(19) United States
(12) Patent Application Publication
(10) Pub. No.: US 2009/0321540 A1
(43) Pub. Date: Dec. 31, 2009

(54) Fuel Injector

(76) Inventors: Joerg Heyse, Besigheim (DE); Michael Frank, Vaihingen/Enz (DE); Walfgang Samenfink, Besigheim (DE)

Correspondence Address: KENYON & KENYON LLP, ONE BROADWAY, NEW YORK, NY, 10004, US

(21) Appl. No.: 12/308,185

(22) PCT Filed: Aug. 17, 2007
(86) PCT No.: PCT/EP2007/058553

§ 371 Date: Jul. 29, 2009

(30) Foreign Application Priority Data
Sep. 5, 2006 (DE) 10 2006 041 475.6

(51) Int. Cl. F02M 61/18

(52) U.S. Cl. 239/548

(57) ABSTRACT

A fuel injector has an orifice plate including a plurality of spray-discharge orifices, which orifice plate is situated downstream from a valve seat member having a fixed valve seat. An inflow opening, which is provided directly upstream from the spray-discharge orifices as incident-flow cavity, is designed in such a way that an incident flow to the spray-discharge orifices takes place largely at a right angle to the longitudinal extension of the spray-discharge orifices. The spray-discharge orifices are placed and oriented in such a way that at least one fuel spray in the form of a hollow cone lamella or full cone lamella is able to be spray-discharged, in which a radially outer region is made up of larger droplets than a radially inner region of the spray.

### BACKGROUND OF THE INVENTION

1. Field of the Invention

The present invention relates to a fuel injector.

2. Description of Related Art

A fuel injector that includes an orifice plate having a plurality of outlet openings downstream from a fixed valve seat is already known from published German patent document DE 42 21 185. Using stamping, the orifice plate is first provided with at least one outlet opening, which extends parallel to the longitudinal valve axis. The orifice plate is then plastically deformed in its mid-section where the outlet openings are located, by deep-drawing, so that the outlet openings extend at a slant relative to the longitudinal valve axis and widen frustoconically or conically in the direction of the flow. This achieves good conditioning and good jet stability of the medium discharged through the outlet openings compared to the fuel injectors known heretofore; however, the manufacturing process of the orifice plate with its outlet openings is very complex. The outlet openings are provided immediately downstream from an exit opening in the valve seat member and, as a consequence, are directly exposed to the flow, the outlet openings themselves defining the narrowest cross section of the flow.

A fuel injector in which an orifice plate having a plurality of outlet orifices is provided downstream from the valve seat is already known from the U.S. Pat. No. 6,405,946. An inflow opening having a larger diameter, which forms an annular inflow cavity for the outlet openings, is formed between an exit opening in the valve seat member and the orifice plate. The outlet openings of the orifice plate are in direct fluid communication with the inflow opening and the annular inflow cavity and covered by the upper boundary of the inflow opening. In other words, there is a complete offset between the outlet openings and the exit opening defining the intake of the inflow opening. The radial offset between the outlet openings and the exit opening in the valve seat member causes an S-shaped flow characteristic of the fuel, which constitutes a measure that promotes atomization. The outlet openings have a round or elliptical cross section.

### BRIEF SUMMARY OF THE INVENTION

The fuel injector according to the present invention has the advantage that, for one, finest atomization of the fuel is achieved in an uncomplicated manner and, for another, the emission values of an internal combustion engine are effectively reduced to a considerable extent. According to the present invention, the fuel injector spray-discharges fuel sprays that have regions of different drop size, where larger droplets form an envelope in an outer region and smaller droplets fill the inner region of a hollow or full cone lamella. This is the result of the specific geometry and orientation of the spray-discharge orifices in conjunction with the horizontal incident flow. In the first start-up cycles (cold start) of an internal combustion engine having externally supplied ignition the outer droplets of the spray-discharged fuel sprays deposit on the intake-manifold walls in the form of a wall film. Only the droplets in the center of the jet and a correspondingly high fuel vapor component enter the combustion chamber directly during the first start-up cycles. It is only a few cycles later that the wall film flows out of the intake manifold into the combustion chamber via the intake valves. In contrast to the related art, the greater droplets ideally assume this wall-film formation according to the present invention. Thus, this more poorly conditioned mixture component will be supplied to the combustion chamber only with a delay, so that, particularly in the start-up cycle, the most optimally conditioned mixture component is supplied into the combustion chamber, and the exhaust emissions during this period are reduced considerably. To this extent, the fuel injector according to the present invention is especially suitable for a manifold injection in order to achieve extremely low emission values in a cold start.

Upstream from the spray-discharge orifices, an inflow opening, which has an inflow cavity and is larger than an outlet opening downstream from the valve seat, is advantageously provided in the valve seat member. In this way the valve seat member already assumes the function of a flow control in the orifice plate. In an especially advantageous manner, due to the design of the inflow opening, an S-deflection is achieved in the flow for better atomization of the fuel since the valve seat member covers the spray-discharge orifices of the orifice plate by the upper boundary of the inflow opening. The spray-discharge orifices are oriented in such a way that they taper radially in an outward direction beginning at a leading edge for the flow. To this extent, the spray-discharge orifices are characterized by a maximization of the effective detachment edge, so that an intended increased detachment effect of the flow in the spray-discharge orifices, and thus the desired droplet distribution, is obtained.

### BRIEF DESCRIPTION OF THE SEVERAL VIEWS OF THE DRAWING

FIG. 1 shows a partially depicted fuel injector.

FIG. 2 shows an orifice plate, in an enlarged sectional view, with a schematic illustration of the droplet distribution for the formation of a hollow lamella spray.

FIG. 3 shows a first exemplary embodiment of an orifice plate in a plan view.

FIG. 4 shows the detailed view of section IV in FIG. 3 as a first spray-discharge orifice.

FIG. 5 shows a second exemplary embodiment of a spray-discharge orifice.

FIG. 6 shows a third exemplary embodiment of a spray-discharge orifice.

FIG. 7 shows a fourth exemplary embodiment of a spray-discharge orifice.

FIG. 8 shows a fifth exemplary embodiment of a spray-discharge orifice.

FIG. 9 shows a sixth exemplary embodiment of a spray-discharge orifice.

FIG. 10 shows a valve end having an orifice plate to form a dual-jet spray, made up of two full lamella sprays.

### DETAILED DESCRIPTION OF THE INVENTION

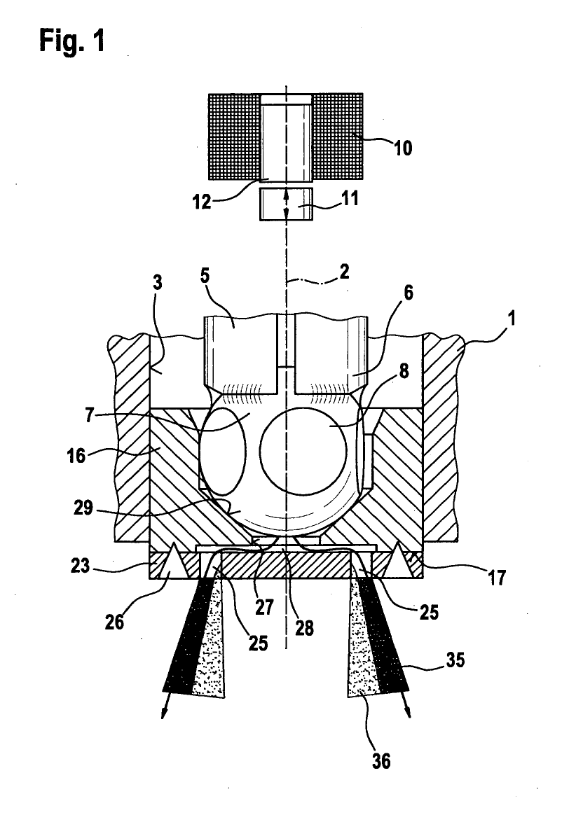

As an exemplary embodiment, FIG. 1 shows a partial view of a valve in the form of a fuel injector for fuel injection systems of mixture-compressing internal combustion engines having externally supplied ignition. The fuel injector has a tubular valve seat support 1, indicated only schematically, which constitutes part of a valve housing and in which a longitudinal opening 3 is formed concentrically with a longitudinal valve axis 2. Situated in longitudinal opening 3 is, for example, a tubular valve needle 5, whose downstream end 6 is fixedly connected to a, for instance, spherical valve closure member 7, on whose periphery, for example, five flattened regions 8 are provided to enable the fuel to flow past.

The fuel injector is actuated in a known manner, e.g. electromagnetically. A schematically sketched electromagnetic circuit, which includes a solenoid coil 10, an armature 11 and a core 12, is used for axial displacement of valve needle 5, and thus for opening the fuel injector against the spring tension of a restoring spring (not shown), or for closing it. A welding seam, for instance formed by laser, connects armature 11 to the end of valve needle 5 facing away from valve closure member 7, armature 11 being aligned with core 12.

A valve seat member 16 is sealingly mounted by welding, for example, on the downstream end of valve seat support 1. At its lower front end 17 facing away from valve closure member 7, valve seat member 16 has a stepped design, and a flat, e.g., single-layer, orifice plate 23 is mounted at front end 17. Orifice plate 23 has at least four, but ideally eight to forty, spray-discharge orifices 25. An inflow opening 28, via which the individual spray-discharge openings 25 are approached by the flow, is provided in valve seat member 16 as extension of an outlet opening 27 formed downstream from a valve seat surface 29. Inflow opening 28 has a diameter that is larger than the opening width of an outlet opening 27 in valve seat member 16, from which direction the fuel flows into inflow opening 28 and finally into spray-discharge orifices 25.

In the immediate incident flow region of spray-discharge orifices 25, inflow opening 28 is designed in such a way that the flow arrives at spray-discharge orifices 25 largely at a right angle to the longitudinal extension of spray-discharge orifices 25, i.e., horizontally according to FIG. 1. The connection of valve seat member 16 and orifice plate 23 is implemented by, for instance, a circumferential, sealing welding seam 26, formed by laser, which is situated outside inflow opening 28.

The insertion depth of valve seat member 16 having orifice plate 23 inside longitudinal opening 3 determines the magnitude of the travel of valve needle 5 since in the case of a non-energized solenoid coil 10, the one end position of valve needle 5 is defined by the seating of valve closure member 7 on valve seat surface 29 of valve seat member 16, which tapers conically in the downstream direction. When solenoid coil 10 is energized, the other end position of valve needle 5 is determined, e.g., by the seating of armature 11 on core 12. The path between these two end positions of valve needle 5 therefore constitutes the travel.

Spray-discharge orifices 25 of orifice plate 23 are in direct fluid communication with inflow opening 28 and covered by the upper boundary of inflow opening 28. In other words, there is a complete offset between spray-discharge orifices 25 and exit opening 27 defining the intake of inflow opening 28. The radial offset of spray-discharge orifices 25 with respect to exit opening 27 results in an S-shaped flow pattern of the medium, i.e., the fuel, in this case.

The S-twist, as it is commonly known, in front of and within orifice plate 23, with several pronounced flow deflections, imparts strong turbulence to the flow, which facilitates atomization. According to the present invention, the specific geometry of spray-discharge orifices 25 in conjunction with inflow opening 28, which the flow may approach horizontally, has an additional positive effect on the atomization of the fluid; it is possible to achieve a hollow lamella spray having regions of different drop size, in which larger droplets form an envelope in an outer region 35, and in which smaller droplets fill inner region 36 of the hollow cone lamella.

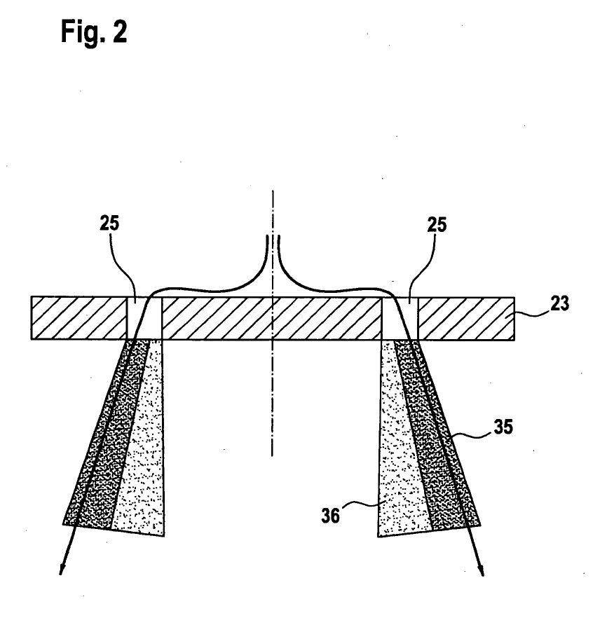

Using FIG. 2, the S-shaped characteristic in the region of orifice plate 23 is to be illustrated once again in schematic form, in an enlarged section; with the aid of this type of incident flow in conjunction with a special design and orientation of spray-discharge orifices 25, the present invention allows a specific droplet distribution within a hollow-lamella spray.

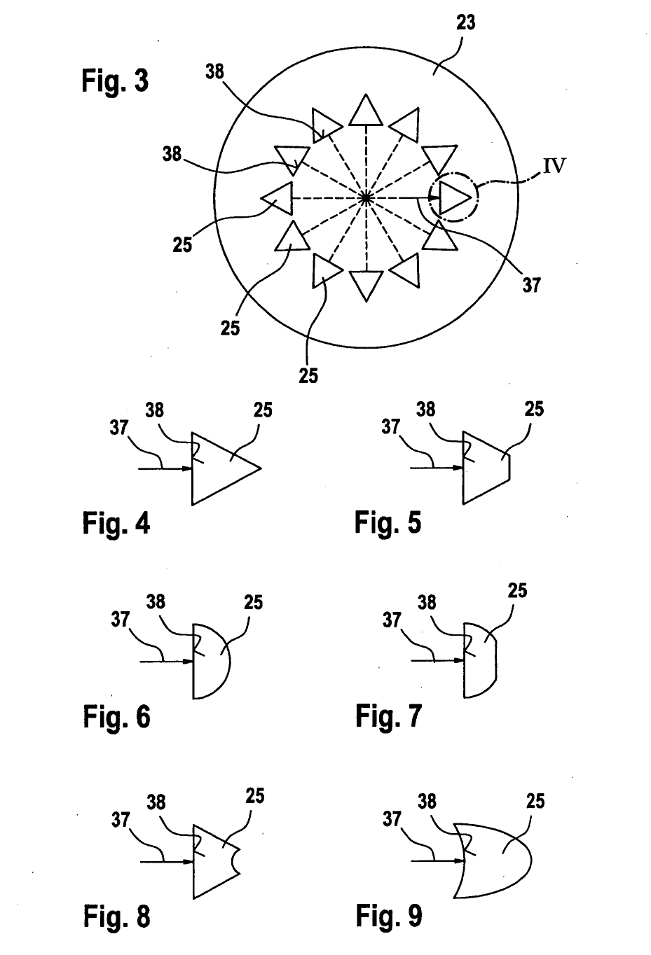

FIG. 3 shows a first exemplary embodiment of an orifice plate 23 in a plan view. Twelve spray-discharge orifices 25, which are distributed on orifice plate 23 in the form of a ring, are provided in this exemplary embodiment. The contour of spray-discharge orifices 25 is triangular. For example, each spray-discharge orifice 25 has the form of an equilateral triangle in cross section. All triangular spray-discharge orifices 25 are oriented in such a way that the horizontal flow, traveling radially from the center of orifice plate 23 in an outward direction, hits spray-discharge orifices at a relatively large leading edge 38. Beginning at this leading edge 38, spray-discharge orifices 25 taper radially in an outward direction or are constricted in the radial direction. Arrows 37 are to indicate, for one, that the incident flow to spray-discharge orifices 25 takes place horizontally to their inlet or largely at a right angle to the longitudinal extension of spray-discharge orifices 25 and, for another, they indicate the manner in which spray-discharge orifice 25 with its large leading edge 38 is aligned relative to longitudinal valve axis 2. To this extent, spray-discharge orifices 25 are characterized by a maximization of the effective detachment edge, thereby achieving an intended greater detachment effect of the flow in spray-discharge orifices 25 and thus the desired droplet distribution.

FIGS. 4 through 9 show six exemplary embodiments of spray-discharge orifices 25 according to the present invention, FIG. 4 showing detail IV from FIG. 3. Spray-discharge orifices 25 are advantageously contoured in such a way that a tapering of spray-discharge orifices 25 is always provided on the side facing away from the incident flow side, i.e., in a radially outward direction. Due to the horizontal approach of the flow to spray-discharge orifices 25 the flow in spray-discharge orifices 25 is directionally diffuse, that is to say, the emerging fluid jet fans out as soon as it leaves spray-discharge orifice 25, but is constricted again in radially outer region 35 by the special contoured form of spray-discharge orifices 25. The immediate fanning prevents the surface tension of the fluid from contracting the emerging jet into a cylindrical jet having a smaller free surface. The enlarged free jet surface in the interior promotes the further disintegration into smaller droplets, whereas, compared thereto, relatively large droplets remain in outer region 35 of hollow cone lamella as envelope. The contours of spray-discharge orifices 25 may take the form of a triangle (FIG. 4), a truncated triangle (FIG. 5), a semicircle (FIG. 6), or a semi-ellipse, a truncated semicircle (FIG. 7), or a truncated semi-ellipse, a rounded, truncated triangle (FIG. 8), a semi-circle or semi-ellipse with a rounded leading edge 38 (FIG. 9) or any other similar form.

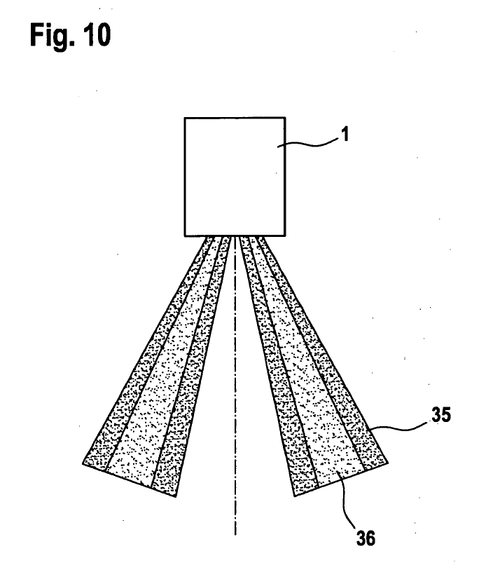

FIG. 10 shows a highly schematic view of a valve end including an orifice plate 23 to form a dual-jet spray made up of two full lamella sprays. The production of such a spray pattern requires that the geometries of the incident flow and the spray-discharge orifice described according to FIGS. 1 through 7 be introduced in orifice plate 23 in duplicate distribution, separately from one another. This requires corresponding incident-flow channels in the region of valve seat member 16, which carry the fluid from the outset into the two desired spray-discharge regions, from where the flow is able to reach spray-discharge orifices 25 via leading edges 38 according to the principle described earlier. Instead of the full-lamella spray shown symbolically, given an appropriate design of spray-discharge orifices 25, it is also possible to generate two hollow lamella sprays, in duplication of the example according to FIG. 2. Such a fuel injector is especially suitable for spray-discharging fuel in the direction of two intake valves.

Orifice plate 23 may be produced by micro-electroplating, with the aid of laser-cutting technology, etching technology or stamping technology. Depending on the production method or the intended purpose, the cross section of spray-discharge orifices 25 is constant across the entire length of spray-discharge orifices 25 or it increases in the direction of the flow.

1-7. (canceled)

8. A fuel injector for an internal combustion engine, comprising:
a valve seat member having a fixed valve seat;
a valve closure member configured to cooperate with the valve seat and axially displaceable along a longitudinal valve axis;
an orifice plate disposed downstream from the valve seat, wherein the orifice plate has a plurality of spray-discharge orifices; and
an inflow opening positioned directly upstream from the spray-discharge orifices and configured in such a way that an incident flow to the spray-discharge orifices takes place substantially at a right angle to a longitudinal extension of the spray-discharge orifices;
wherein the spray-discharge orifices are configured and oriented in such a way that at least one fuel jet is able to be discharged in a spray, and wherein a radially outer region of the spray includes larger droplets than a radially inner region of the spray.

9. The fuel injector as recited in claim 8, wherein the spray-discharge orifices are configured to radially taper in an outward direction starting at a leading edge for the incident flow.

10. The fuel injector as recited in claim 9, wherein the number of spray-discharge orifices is between eight and forty.

11. The fuel injector as recited in claim 9, wherein the contour of the spray-discharge orifices is one of a triangle, truncated triangle, semi-circle, semi-ellipse, truncated semi-circle, truncated semi-ellipse, rounded truncated triangle, semi-circle or semi-ellipse with a rounded leading edge.

12. The fuel injector as recited in claim 9, wherein the inflow opening is provided at a lower front end of the valve seat member.

13. The fuel injector as recited in claim 9, wherein the spray-discharge orifices are configured to enable spray-discharge of one of a hollow lamella spray or a full lamella spray.

14. The fuel injector as recited in claim 9, wherein the orifice plate is formed with the aid of one of galvanic metal deposition, laser-cutting or stamping.
